(19) United States
(12) Patent Application Publication
(10) Pub. No.: US 2020/0258135 A1
(43) Pub. Date: Aug. 13, 2020

(54) TRAVEL MOBILE APPLICATION

(71) Applicant: FLYORITY, LLC, Woodland Hills, CA (US)

(72) Inventors: David Bret STERNLIGHT, Woodland Hills, CA (US); William Richard CULLEN, San Clemente, CA (US); Christopher Graham ALLAN, Nutley (GB); Jared Dylan BERNARD, Westlake Village, CA (US)

(21) Appl. No.: 16/784,153

(22) Filed: Feb. 6, 2020

Related U.S. Application Data
(60) Provisional application No. 62/869,269, filed on Jul. 1, 2019.
(60) Provisional application No. 62/802,560, filed on Feb. 7, 2019.

(51) Int. Cl. G06Q 30/06; G06Q 50/30; G06Q 10/02; H04W 4/021

(52) U.S. Cl. CPC G06Q 30/0611; H04W 4/021; G06Q 10/02; G06Q 50/30

(57) ABSTRACT

A method is presented. The method includes receiving a first user's travel information and identifying one or more second user's scheduled for a same travel vehicle as the first user. The one or more second user's may be identified based on the first user's travel information and the one or more second user's travel information. The method also includes providing an interface for the first user to communicate with the one or more second user's.

### CROSS REFERENCE TO RELATED APPLICATIONS

This application claims the benefit of U.S. Provisional Patent Application No. 62/802,560, filed on Feb. 7, 2019, titled “AIR TRAVEL MOBILE APPLICATION,” and U.S. Provisional Patent Application No. 62/869,269, filed on Jul. 1, 2019, titled “AIR TRAVEL MOBILE APPLICATION,” the disclosures of which are expressly incorporated by reference herein in their entireties.

### BACKGROUND

### Field

Certain aspects of the present disclosure generally relate to mobile device applications and, more particularly, to a system and method for improving a user's travel experience via a mobile application.

### Background

Traveling is often an exhausting experience for a traveler. Due to security measures, cost cutting, and other factors, traveling has turned into an unpleasant experience. For example, travelers often face long lines, delays, errors in seat arrangements, and other types of discomforts.

Travel carriers and ports (e.g., airports, train stations, bus stations, etc.) have attempted to improve the travel experience. For example, airlines provide mobile applications for check-in, food purchase, and entertainment. Still, these applications are limited to specific airlines. Additionally, these applications do not address fundamental concerns, such as seat assignments, delayed flights, and the overall airport experience. As such, it is desirable to improve the air travel experience for travelers.

### SUMMARY

In one aspect of the present disclosure, a method is disclosed. The method includes receiving a first user's travel information. The method also includes identifying one or more second user scheduled for a same travel vehicle as the first user. The method still further includes providing an interface for the first user to communicate with the at least one second user.

In another aspect of the present disclosure, a non-transitory computer-readable medium with non-transitory program code recorded thereon is disclosed. The program code is executed by a processor and includes program code to receive a first user's travel information. The program code also includes program code to identify one or more second user scheduled for a same travel vehicle as the first user. The program code further includes program code to provide an interface for the first user to communicate with the at least one second user.

Another aspect of the present disclosure is directed to an apparatus. The apparatus having a memory and one or more processors coupled to the memory. The processor(s) is configured to receive a first user's travel information. The processor(s) is also configured to identify one or more second user scheduled for a same travel vehicle as the first user. The processor(s) is further configured to xxxx. The processor(s) still further configured to provide an interface for the first user to communicate with the at least one second user.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example of a flow diagram for the mobile application according to aspects of the present disclosure.

FIGS. 2-11 illustrate examples of different screens for a mobile application according to aspects of the present disclosure.

FIG. 12 illustrates an example of a system according to aspects of the present disclosure.

FIG. 13 illustrates an example of an architecture of a mobile client application according to aspects of the present disclosure.

FIG. 14 illustrates an example of a flow diagram for a method according to aspects of the present disclosure.

### DETAILED DESCRIPTION

The detailed description set forth below and, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

As discussed, traveling is often an exhausting experience for a traveler (e.g., passenger). Due to security measures, cost cutting, and other factors, travelers often face long lines, delays, errors in seat arrangements, and other types of discomforts. It is desirable to improve the air travel experience for travelers. Aspects of the present disclosure provide a mobile application for improving a passenger's travel experience. Aspects of the present disclosure are not limited to air travel and are contemplated for other types of travel, such as travel by bus, train, or another type of vehicle. For simplicity, the examples below are provided in the context of air travel.

The mobile application may include functions for real-time inter-passenger communication. The communications may be with regard to seating, passenger's names, seat upgrades, items to be purchased by one passenger on behalf of another passenger, boarding notifications, and/or other functions.

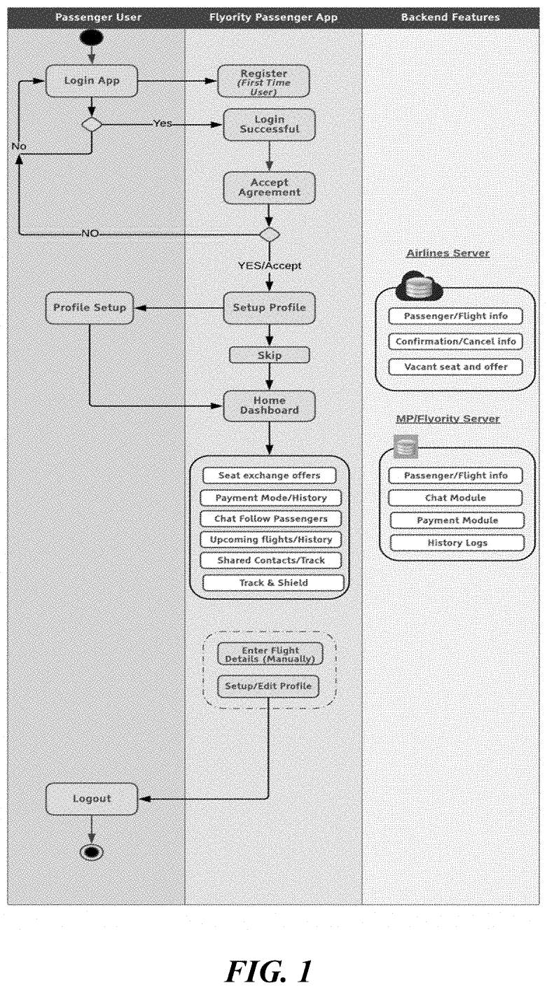

FIG. 1 illustrates an example of a flow diagram for the mobile application according to aspects of the present disclosure. As shown in FIG. 1, a user (e.g., passenger/traveler) may log in to the application. If it is the user's first time using the application, the user may be prompted to accept a user agreement.

In one configuration, features of the mobile application are integrated with a mobile application of an airline. In another configuration, the mobile application is a standalone product. Additionally, one or more features may be integrated with an airline's mobile application that co-exists with the standalone product.

Upon accepting the user agreement, the user may create a profile. Alternatively, the user may skip the profile setup. Following the profile setup, or after skipping the profile setup, a home dashboard is presented to the user. The home dashboard may offer various functions, such as seat exchange offers, payment mode/history, chat with other passengers, upcoming flights/history, shared contacts, luggage tracking, and other functions.

As shown in FIG. 1, the passenger information, flight information, confirmation information, cancelation information, and seat information (e.g., vacant seat and seat offers) may be obtained from one or more airline servers. Additionally, passenger information, flight information, chat functions, payment functions, and history logs may be obtained from a server associated with the mobile application (e.g., Flyority™ server). In some cases, if the passenger information and/or flight information is not obtained from an airline server, the user may manually provide the flight details.

Passenger information and/or flight information may also be obtained from a passenger's email confirmation, mobile confirmation, text confirmation, or other information stored on a user's mobile device, mail server, text server, social media apps, etc. That is, the application may integrate with the user's communication platforms (e.g., text message applications, social media, e-mail, etc.) to scrape travel data from the communication platform.

In one configuration, the mobile application provides a function for a user to connect with other users. The users may exchange information in a chat room where users chat with other users and/or transmit private messages. A message board may be provided for a user to ask favors from other users by posting a message. The message board may correspond to a specific flight. Thus, when the flight has ended, the application may clear out all messages from the message board.

In one configuration, the chat function is activated on a per flight basis. Each chat room may be activated twenty-four hours before departure time and deactivated when boarding begins. The boarding time may be obtained from an airline server and/or another data source. A user may enter the chat room once the user has checked-in or once the chat room is activated. The application may be notified by the airline when the user has checked-in to the flight. Additionally, or alternatively, the user may upload their boarding pass to the application, such that the application verifies that the user has checked-in to the flight.

For security purposes and passenger convenience, the chat may be deactivated once boarding ends. In one configuration, the chat may reactivate for a time period, such as thirty minutes, after takeoff. The time period for an active chat may be set by each airline or federal aviation administration (FAA) rules.

According to aspects of the present disclosure, one or more functions may be enabled or disabled based on a user's location. For example, the bartering system and/or the chat system may be enabled when the system confirms that the passenger is at the airport and/or has cleared security. The passenger's location may be determined using the passenger's mobile device. In one configuration, the mobile device's location system (e.g., GPS) and/or triangulation is used to determine the passenger's location. Additionally, or alternatively, the user's location may be tracked by an associated luggage tracker with a location system.

Additionally or alternatively, the passenger's location may be determined from an airline. That is, the integration with an airline's system provides the passenger's location. For example, the system may determine the passenger is at the airport if the airline indicates that the passenger has checked-in at the check-in counter and/or checked-in luggage. In another example, the system determines that the passenger is at the airport when the airline confirms that the passenger has boarded their flight.

The application may be integrated via an airline's backend interface (e.g., application protocol interface (API). Application specific interface may be generated to retrieve data from the airline's system.

The application may also provide a function to display details of a user's upcoming flights. The message board may be provided for each of the user's flights. Additionally, a seat exchange may be provided, such that users can swap (e.g., exchange) seats. For example, the user may indicate that their seat is available for trade. Additionally, the user may place an offer on a seat that is open for trade.

In conventional systems, passengers may bid on open seats. Bidding on open seats prior to a flight may create security and safety risks. For example, the seating on some planes is balanced based on passenger weight. Therefore, a passenger moving to an empty seat may cause unbalance. As such, it is desirable for passengers to swap seats rather than moving from an occupied seat to an unoccupied seat.

Therefore, in one configuration, users barter for their seats. Specifically, users may exchange their seats in terms of digital currency. The currency may be stored in a user's virtual wallet. The digital currency may be loaded into the wallet from a user's bank account, credit card, debit card, or other banking platform. For example, a user can request a preferred seat and offer to pay money for it. The offer may be increased, decreased, or canceled prior to acceptance. As another example, a user may offer their seat up for a trade (e.g., trade fee). In this example, the user may offer to exchange seats between business and economy class for a certain value.

In yet another example, seats may be auctioned. In one configuration, the price of a seat is adjusted to match demand. For example, the price of a window seat may increase when fewer window seats are available, or decrease when more window seats are available. Additionally, the price of a seat or an amount for a seat offer may be adjusted based on a time frame. For example, after a certain time, if an offer is not accepted, a price may be decreased per minute. As another example, a passenger may offer to pay $50 for a window seat. If the offer is not accepted within a certain time period, the price may increase per time period (e.g., one minute). In one configuration, the auction process is transparent to the public. The auction may be made public when a number of passengers on a flight are greater than a threshold.

In one configuration, the system may automate the auction process, such that seats are automatically swapped. That is, the system may automatically pair passengers based on their preference. The preferences may be determined based on user input or identified based on user history. For example, a first passenger may prefer an aisle seat while a second passenger may prefer a window seat. In this example, if the first passenger is given a window seat and the second passenger is given an aisle seat, the system may autonomously switch the passengers' seats. That is, the system automatically pairs these passengers and auto-swaps the seats. The auto-swap may be performed for a fee. The auto-swap may be a default setting.

Seat preferences are not limited to window, aisle, or middle. Passengers may also select a zone within a plane (e.g., near the front of the plane, in the middle, or in the back). Additionally, passengers may be able to pinpoint an exact seat. For instance, if a family is traveling together, and two of the three of them are together, one can offer a bid to the third person in that window/middle/aisle section to switch/barter.

A seat map protocol may also be integrated. The seat map protocol may be from an external site. The seat map protocol may include plane configurations for airlines/flight numbers, such that one can easily view and choose which seats they want to bid on or where the offer is coming from (e.g., seats to move to). Additionally, or alternatively, the seat maps may be provided from the airline.

It is desirable to confirm that users actually moved seats when a match/barter was successful. In one configuration, the flight attendants ensure compliance. In another configuration, an artificial intelligence system verifies the exchange. In this configuration, the passengers captures an image of their seat/row number. The image may be of the row number of the row adjacent to the passenger's row. In another example, the image may also be taken above head level towards the front or back of the airplane to have an approximation of where one is sitting.

The image may be uploaded to a device associated with the application. The device may analyze the image to determine that the passenger has moved to the appropriate seat. The analysis may include identifying the passenger's seat/row number from the image and verifying that the passenger's seat/row number corresponds to the seat/row number of the exchange.

As another example, the analysis may include identifying the row number of the row adjacent to the passenger's row from the image. The device may then verify that the identified row number is the row that is adjacent to the row number of the exchange. The adjacent row may be known based on airline seat maps.

In yet another example, the analysis may include counting a number of rows ahead or behind the passenger when the image is taken above head level towards the front or back of the airplane. For example, an image may include five rows of seats and each row shows seat back or the backs of passenger heads. In this example, the device may determine the image is taken towards the front of the plane and the passenger is in row six. The analysis may further determine whether the passenger is in economy, business, or first class based on a number of seats in a row and/or the width of each seat.

In yet another example, a passenger may capture a video of a bad actor who is not willing to move after confirming a match and uploading the video to the application for proof In still another example, a witness or witnesses who have the application may attest to a passenger that is not willing to move. Passengers without the application may offer their contact number to serve as a witness.

Aspects of the present disclosure are not limited to travel (e.g., airline travel) and may be applied to other service industries. For example, aspects of the seat exchange may be applied to an entertainment or sporting venue. In one configuration, users in a stadium may auction seats and/or purchase auctioned seats via the application. A map of the stadium may be integrated into the application.

The verification system may also be applied to the seat exchange in the stadium. For example, a user may take an image of a section number or the playing field (e.g., football field, basketball court, concert stage, etc.) to verify that the seat exchange has occurred.

The virtual wallet provides an opportunity for users to earn points in their virtual wallet. The points may be redeemed for various items. The mobile application handles payment scenarios when an Internet connection is available. The user may add money to the wallet via a bank transfer.

As discussed, a user may communicate with other passengers who are boarding the same flight. In one configuration, passengers may interact when their mobile device is offline or in an airplane mode (e.g., without an Internet connection) while onboard.

Aspects of the disclosure are not limited to the above mentioned functions. Other functions are also contemplated, such as a dynamic content feed. Another function is directed to planning a trip via a collaboration with a rideshare application. The dynamic content feed provides user specific updates, offers, etc. The dynamic content may also include updates for airline offers, airport shopping, and offers from cab/ride-share partners.

The chat mode may be a global chat or an airplane chat. The global chat mode provides a feature for users to chat with connected members while the application has Internet access. In airplane mode, users can chat with other passengers while they are on the flight without Internet access. For example, a user may use a feature of the application to pay someone to use his or her power bank for the flight. A passenger may need a power bank if there are no electrical outlets (or a person is seated near one that does not work). In yet another example, users may offer unneeded drink tickets for sale on a flight.

The mobile application provides a function for users to keep track of their previous, present, and upcoming events. That is, the application may maintain a history of previous trips, maintain a history of previous payments, maintain a history of previous conversations and chats, and display records of upcoming events (e.g., flights).

In one configuration, the application is integrated with an airport concessionaire. In this configuration, a menu for items, such as comfort products, gifts, magazines, snacks, meals, etc., may be provided. The passenger may pick up items at the concessionaire, or a delivery service may deliver items directly to the gate. The integration with the application would let the concessionaire know the passenger's name and which gate they will be flying out of. The passenger may also be connected with a representative of the concessionaire. As such, there could be communication about the order or where to pick up the order.

Additionally, or alternatively, the application may integrate with both a food concessionaire (such as Skychefs/LSG or Gate Group) and an airline. In this example, the customer may have the ability to have a customized, pre-ordered meal to be delivered to the airplane when they restock it for the next flight. The customer may have the ability to choose meal types and a time when the meal is served.

Communications between passengers for bartering, chatting, or other functions may be provided via WiFi, satellite communications, NFC, Bluetooth, or other communication channels. In one configuration, users of the application may communicate via the flight's USB ports. That is, an airline may provide a USB port on a seat for device power. The application may use the USB port to send/receive communications with other users of the application.

The USB port may also be used to integrate with the airplane back-of-seat monitor. The integration may also be made without the USB connection. The integration may allow passengers to use the application features without the use of their mobile device, or in addition to the use of the mobile device.

Integration with airlines provides additional features. For example, the airline staff for that flight would be able to communicate directly (and vice versa) with the passengers through the application. The airline may offer immediate upgrades (paid or otherwise), sell meals in advance, provide seat changes, notify passengers of delays, and gate changes, communicate approximate boarding times, notify passengers of group boards, and offer money/compensation or auction seats on overbooked flights. Passengers/users could be in communication with gate agents if they are running late.

Additionally, when integrated with an airline, a user could use the application as a communication tool with flight attendants and/or pilots. Users may also order drinks, order food, provide do-not-disturb notification, ask flight attendants to leave drink or food while they are sleeping or going to the bathroom, asking for assistance in any way, etc.

Without integration, airline staff may still use the application to communicate with passengers. In this way, integration with the airline may be bypassed.

In one configuration, a first user may offer a second user a convenience fee to carry the second user's carry-on onto the plane (if the first user does not have a carry-on) and store the carry-on in an overhead bin.

When integrated with an airline, the application may allow users to lease overhead bin space (at a cost) for the flight. In this example, a system notifies passengers that the space is already reserved. The flight attendants may regulate the reservations. Alternatively, the overhead bins may open via a code provided by the application, such that the bin is only used by the passenger that leased the bin.

Aspects of the present disclosure may also use predictive analysis. The predictive analysis determines the average barter price for each barter-type (e.g., middle-to-aisle) for that flight route or a flight of that approximate duration. Accordingly, the user may see what the price should be. In one configuration, this information may be used to offer an auto-barter that locks people into the exact average price for the barter. In this configuration, a user is charged and pays the going rate without the manual barter process.

The predictive analysis system may also determine how much a user may will be willing to pay for a flight route and/or flight lengths so that they do not pay more than a specific rate. In another configuration, the predictive analysis system determines how much a user may be willing to pay, has paid, or how much money has been received in the past. Based on this information, a function determines how the flight times lead to a prediction of what a user should be willing to pay or receive for other flight times.

In one configuration, the application learns a user's favorite meal, snack, and preferences. Based on integration with an airport concessionaire, the application can offer up a user's favorite items to purchase. The user's favorite items may be available for pickup or delivery to the gate.

In one configuration, crowdsourcing is integrated into the application. Crowdsourcing may gather information from various applications, such as Waze, Uber, and Lyft. Other information may be obtained from a length of a check-in line, a security line, and/or customs line. Different customers may provide information regarding their time in a line.

Additionally, or alternatively, line time may be determined by tracking a passenger's location. The location may be tracked via the passenger's mobile device's triangulation, GPS, and/or their Track & Shield™ GPS location. The crowdsourced times may be used to determine when a passenger should leave their current location to arrive at the airport at a predetermined time. The application also takes into account if one is using another mode of transportation to the airport, and asks the user how much time it will take them to get to the airport, add in the lines that they will need to wait in, and let them know when to leave their departure-to-airport place.

The application may integrate with a luggage tracking feature, such as Track & Shield™. This integration may notify a passenger when their luggage is being loaded onto the plane within a geofence zone. The integration may also notify the passenger when the luggage comes within WiFi or Bluetooth range and/or when the luggage arrives at the luggage carousel (e.g., based on a speed of movement).

As discussed, flight-specific passengers may communicate with each other to obtain information. This information includes, but is not limited to, line lengths, the assigned gate number, suggested meals in the terminal, boarding times, when pre-boarding starts, or when a group number is called, asking someone from the back of the plane to bring a bag stored in the overhead bin space up to the front of the plane.

Additionally, the application may determine which users are near the gate, based on their mobile device's triangulation and/or GPS, and send selective push notifications. Confirmed notifications go out to users that have opted-in to receive these notifications. If integrated with airlines, the airlines may automatically send boarding group numbers to the application.

As discussed, a confirmation function is provided. The confirmation function confirms the completion of a barter or purchase. Refunds and/or penalties may be imposed if a barter or purchase is not confirmed.

The application may distinguish emergency exit rows, as well as confirm that a passenger is at least 15 years old and capable (e.g., physically able to help in case of emergency) of sitting in the emergency exit row. The application may also distinguish a premium economy class that can also barter.

The application may include a “get to know” feature for users to opt-in to be able to scroll through the passengers and search for common interests. The passengers may communicate with each other through our application, or make offers to neighbors to sit next to each other on the plane. Seat exchanges are not limited to a certain number of exchanges. Passengers may perform multiple seat exchanges.

As discussed, the application may permit users to order food ahead of time from restaurants in the terminal. In one example, passenger A places a food order and has passenger B pick up the food. Passenger A would have to send passenger B a code to show the restaurant that passenger B is authorized to pick up the food. Added features are provided for passenger A or B to confirm that the food order was delivered to passenger A, such that payment to passenger B can be processed. The confirmation may be provided via a picture of the food, a scan of the physical receipt by Passenger A, or via other confirmation functions.

The application may also be used to barter boarding zone/positions. For example, some airlines use numbered boarding positions (e.g., A1-60, B1-60, C1-60). In this example, a user with C22 can offer money to change boarding positions with someone in an A boarding group. The boarding zone barter may also be used to barter within boarding groups.

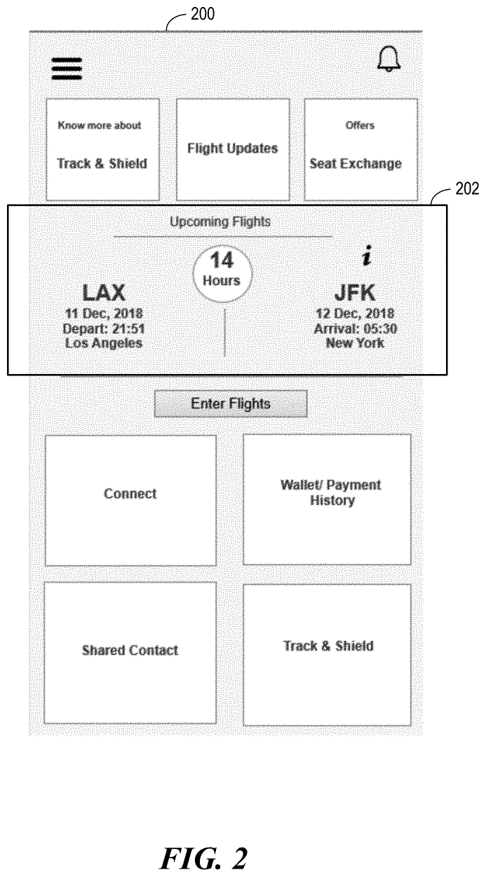

FIG. 2 illustrates an example of a home screen 200 for a mobile application according to aspects of the present disclosure. As shown in FIG. 2, the home screen 200 may include a dynamic content area 202. In this example, the dynamic content area 202 displays upcoming flight information. The home screen 200 also provides access to other functions, such as flight updates, seat exchange offers, wallet/payment history, shared contact information, connect (e.g., chat), luggage tracking, and other options.

In one configuration, a luggage tracker may be integrated into the application. The luggage tracker provides functions for passengers to view the location of their luggage throughout the trip, except when the airplane is traveling over a certain speed (e.g., 150 MPH). The luggage tracker may be a positioning device (e.g., GPS device) attached to the luggage.

According to aspects of the present disclosure, a user may drop a pin in an area to create a virtual fence. When the luggage tracker enters the area (e.g., crosses the virtual fence), the mobile application may generate a notification. The luggage tracker may communicate with the mobile device via a wireless connection, such as WiFi or Bluetooth.

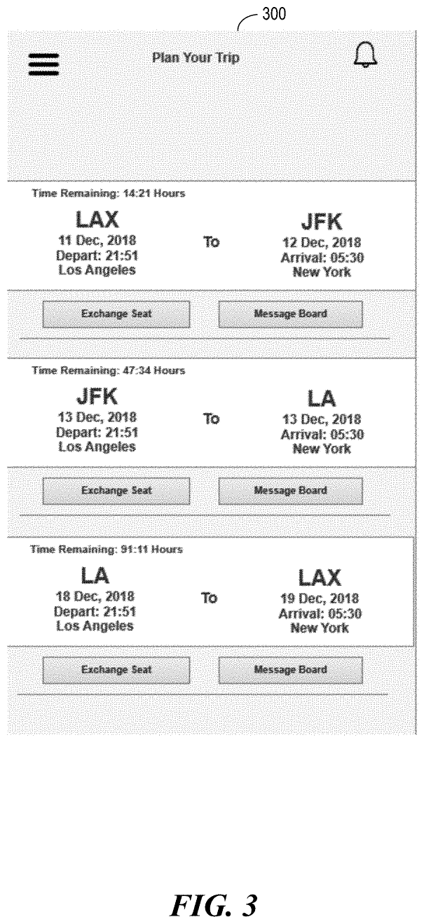

FIG. 3 illustrates an example of a flight details screen 300 according to aspects of the present disclosure. As shown in FIG. 3, each one of the user's flights is displayed on the flight details screen 300. For each flight leg, the user may access a message board and a seat exchange.

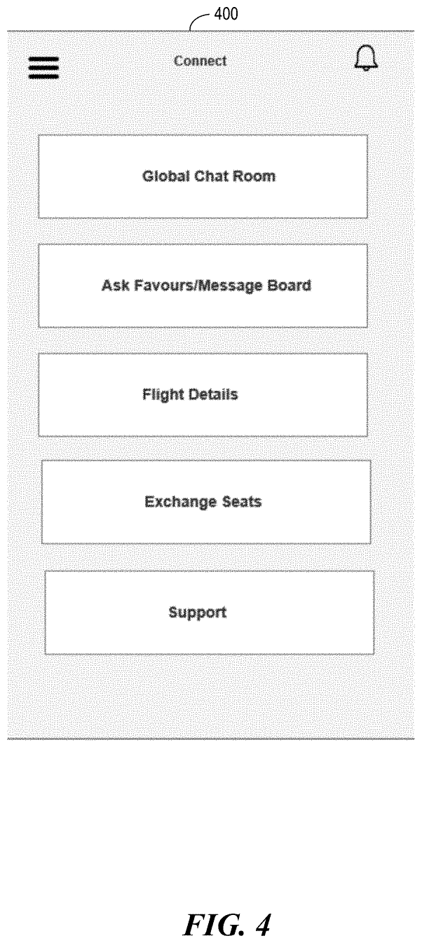

FIG. 4 illustrates an example of a connect screen 400 according to aspects of the present disclosure. As shown in FIG. 4, the connect screen 400 may provide access to a global chat room, message board, flight details, seat exchange, and support. The connect screen 400 may be accessed from the home screen.

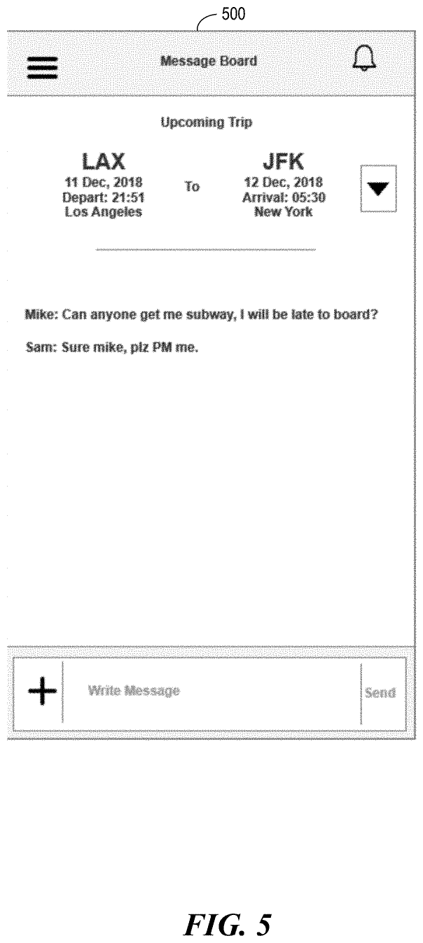

FIG. 5 illustrates an example of a message board 500 according to aspects of the present disclosure. As shown in FIG. 5, the message board 500 may provide details of the current flight. Additionally, users may exchange messages in the message board 500. For example, a user may ask another user to buy him a sandwich because he is running late. The users may then exchange the currency in their digital wallet for the sandwich. The mobile application may use GPS or other positioning systems to identify users that have made it past security.

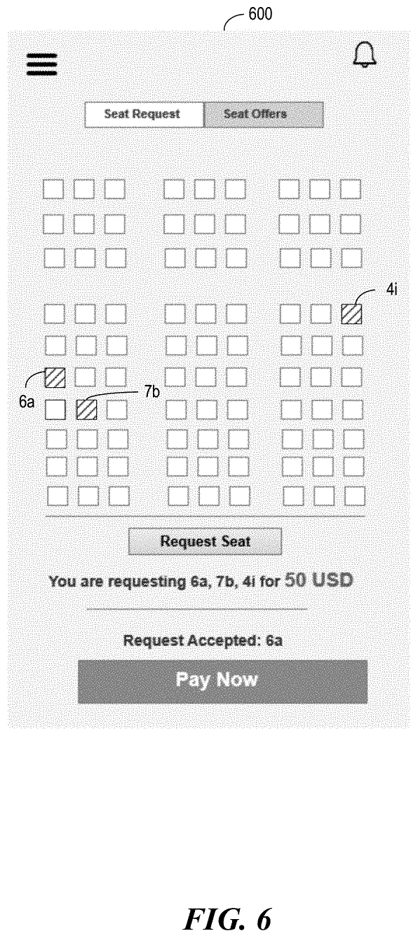

FIG. 6 illustrates an example of a seat request screen 600 of a seat exchange according to aspects of the present disclosure. As shown in FIG. 6, the seat request screen 600 may provide a seating chart for the current flight. In this example, a user may request specific seats. In FIG. 6, the user is requesting seats 6a, 7b, and 4i for $50. Additionally, the occupant of seat 6a has accepted the offer. The accepted offer may be displayed on the seat request screen 600 with an option to pay for the seat.

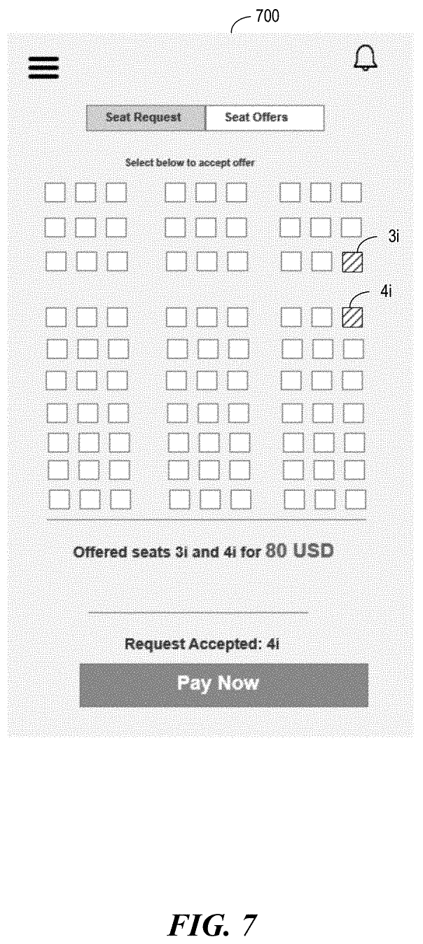

FIG. 7 illustrates an example of a seat offer screen 700 of a seat exchange according to aspects of the present disclosure. As shown in FIG. 7, the seat offer screen 700 may provide a seating chart for the current flight. In this example, a user may view offered seats or may offer a seat. In FIG. 7, one or more users have offered seats 4i and 3i for $50. The accepted offer may be displayed on the seat offer screen 700 and provides an option to pay for the seat.

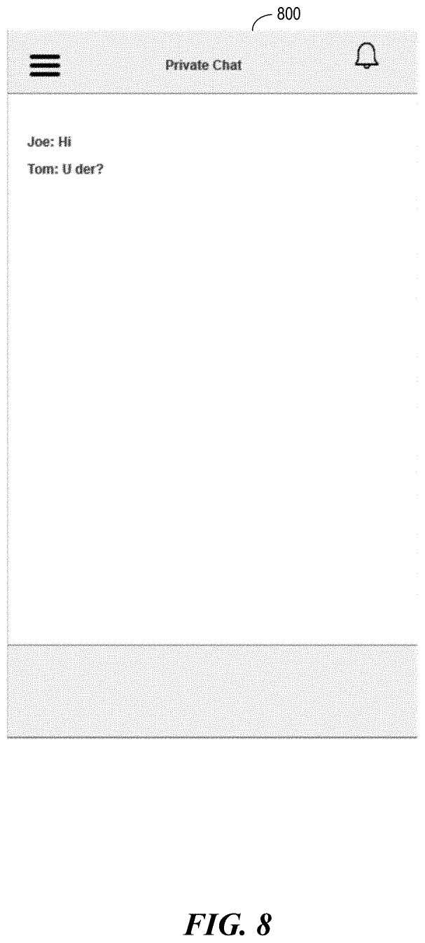

FIG. 8 illustrates an example of a private chat screen 800 according to aspects of the present disclosure. As shown in FIG. 8, the private chat screen 800 is a direct message between two users. The chat may also be a chat room where multiple users may chat with each other. The private chat screen 800 may be accessed from a chat room.

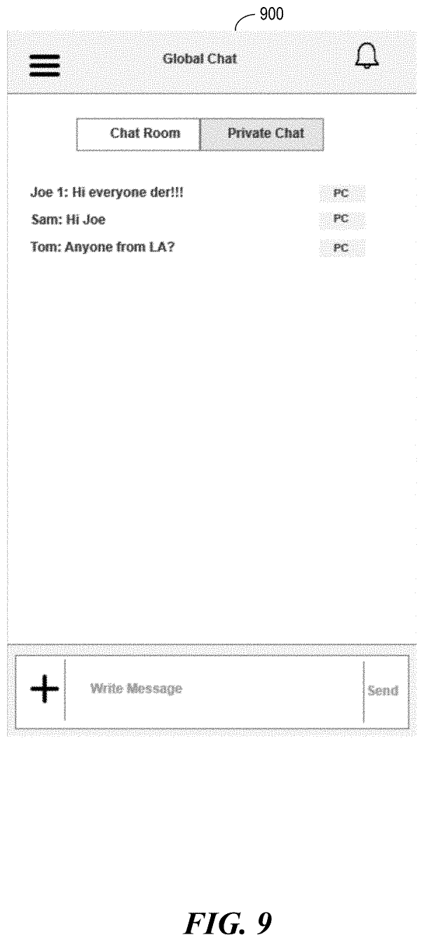

FIG. 9 illustrates an example of a global chat screen 900 according to aspects of the present disclosure. As shown in FIG. 9, the global chat screen 900 is a chat room where multiple users may chat with each other. The private chat screen 800 may be accessed from the global chat screen 900.

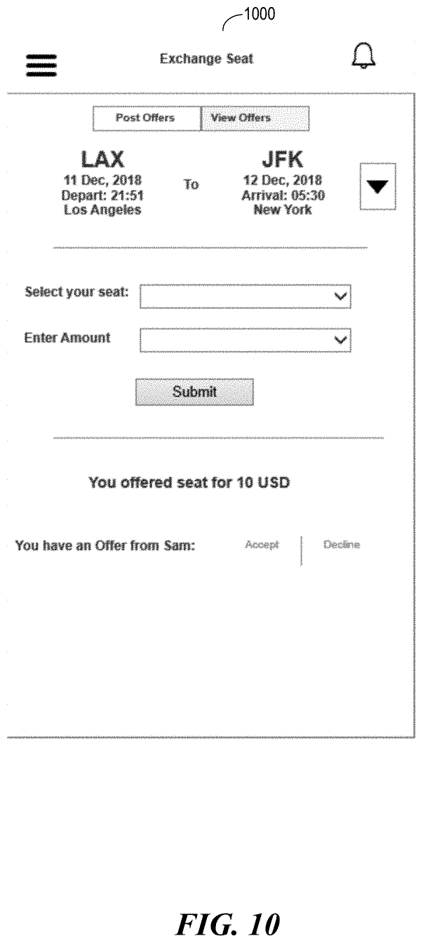

FIG. 10 illustrates another example of a seat offer screen 1000 of a seat exchange according to aspects of the present disclosure. As shown in FIG. 10, the seat offer screen 1000 may provide the user menus for offering their seat. The user may select their seat and provide an amount. The seat offer screen 1000 may also display offers received from other users.

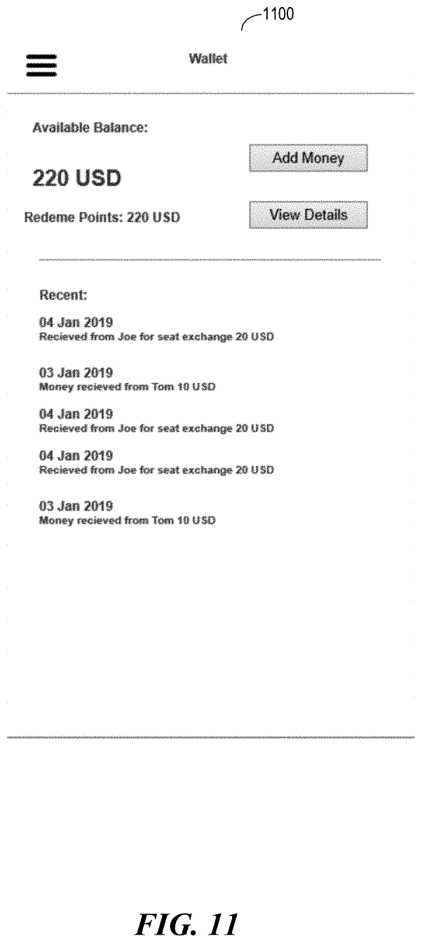

FIG. 11 illustrates an example of a wallet 1100 according to aspects of the present disclosure. As shown in FIG. 11, the wallet 1100 may display a current balance, transaction history, and other options. The other options may include an option to add money or view further details of the balance. The balance may be used to purchase seats, to barter, or to provide payments to other users.

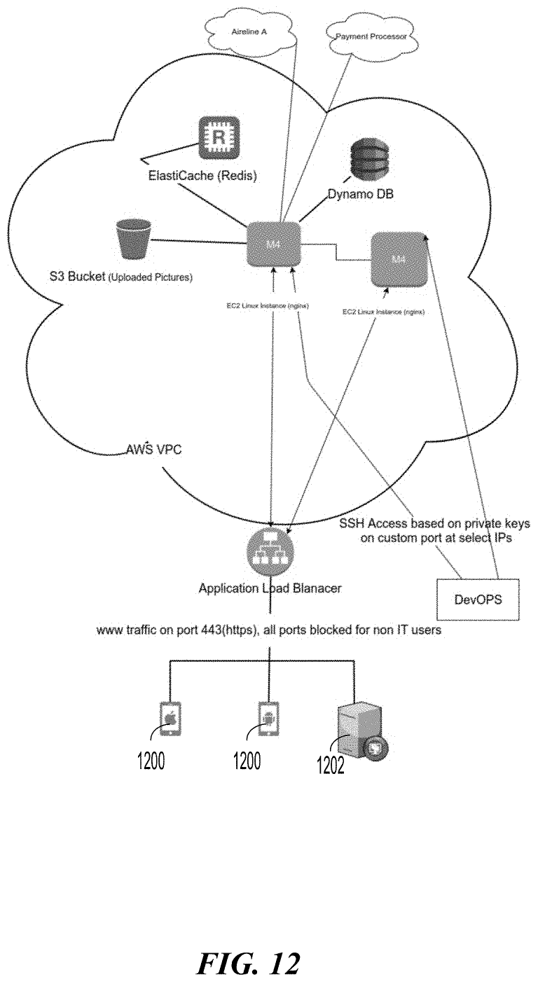

FIG. 12 illustrates an example of a system according to aspects of the present disclosure. The system may be accessed by different types of user devices 1200, 1202, such as a mobile device 1200 or a desktop computer 1202. The system of FIG. 12 illustrates a server architecture and database structure.

Various types of communication levels are proposed for a user (e.g., passenger) type. The user is a passenger that is traveling with an airline. The first communication level for this user may be a passenger-to-passenger (P2P) communication level. The P2P level provides for a barter system (e.g., seat exchange), where a passenger can request a preferred seat and offer to pay for the preferred seat. The offer can be increased, decreased, or canceled at any time. The passenger may also offer their seat up for a trade (trade fee), be notified of an aisle seat, and/or access an auction system in the P2P level.

Other communication levels may include a passenger-to-airline (P2A) level and a passenger-to-mobile application server (P2F) level. For example, the passenger may directly communicate with the airline (e.g., P2A) or a mobile application server (e.g., P2F).

A mobile application architecture is a set of patterns and techniques which are to be followed to build a mobile application. The techniques and patterns are formulated, keeping concept standards and industry standards in mind. The mobile application may be structured as a multi-layered application consisting of user experience, business, and data layers.

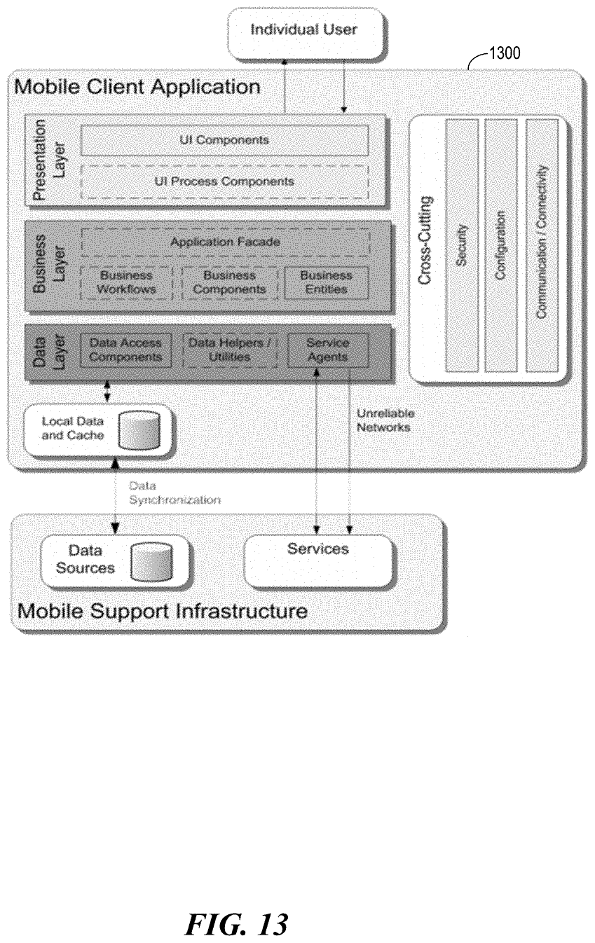

FIG. 13 illustrates an example of an architecture of a mobile client application 1300 according to aspects of the present disclosure. The architecture of FIG. 13 may be referred to as an N-tier architecture or a multi-tier architecture. As shown in FIG. 13, the application (e.g., software) is engineered to include processing, data management, and presentation functions physically and logically separated. That is, these different functions are hosted on several machines or clusters. As such, services are provided without resources being shared and, therefore, these services are delivered at top capacity.

In the example of FIG. 13, the N-tier architecture is divided into multiple layers (e.g., tiers). The layers include a presentation layer (e.g., what the users see on the frontend), a business layer (e.g., business logic behind a flow of an application), and a data layer (e.g., storage of data, such as user data, flight data, etc.). The processing of the different layers may be distributed between the client (e.g., mobile device) and the server.

An individual user interacts with the application 1300 (e.g., mobile client application) through the presentation layer. The presentation layer includes a user interface (UI) component and a UI processing component. As such, the presentation layer is the user interface and where the user enters their personal information. The presentation layer also passes the user's different actions to the business layer.

The presentation layer may also include data binding components and object representations of data. The presentation layer may access the business (e.g., middle) layer by using a service. The presentation layer does not directly access the data layer. The presentation layer communicates with the data layer by way of the data access component in the middle layer

The business layer is the layer that the presentation layer and the data layer use to communicate with each other. The business layer includes business components such as business rules and data validation as well as application facade and business entities. The data layer includes data access components. The data access components include object representations of data, such as language integrated query (LINQ) to structured query language (SQL) entity classes. Data access components also include common application services, such as authentication, authorization, and personalization.

The business layer may also be referred to as the application layer. The business layer identifies what is permitted by the application and what is feasible, and it may make other decisions. The business layer may connect to the data layer by using a data connection. This data connection may be stored in the data access component. The business layer also writes and reads data into the data layer.

The data layer may communicate with a server that stores an application's data in the data sources. The data layer may also obtain data from local data and a local cache. The data layer cannot be accessed directly from the client in the presentation layer. Instead, the data access component in the business layer is used for communication between the presentation and data layers. The data layer includes data helpers/utilities and service agents. The service agents communicate with the services of the mobile support infrastructure.

Cross-cutting services may run across all layers. These services include security, configuration, and communication/connectivity.

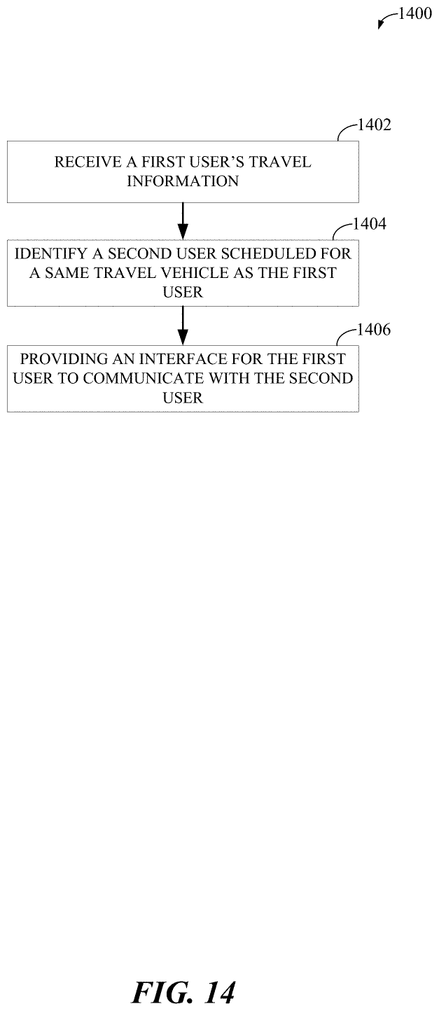

FIG. 14 illustrates a flow diagram for a method according to aspects of the present disclosure. As shown in FIG. 14, at block 1402, a mobile application receives a first user's travel information. The first user's travel information may be received from an airline database or an input from the first user. In one configuration, the mobile application integrates with an airline to retrieve data from the airline's database. Additionally, or alternatively, the mobile application may obtain travel information from the first user's email, social media, mobile device, computer, or other source.

At block 1404, the mobile application identifies a second user scheduled for a same travel vehicle as the first user. The second user's travel information may be received from an airline database or an input from the second user. Additionally, or alternatively, the mobile application may obtain travel information from the second user's email, social media, mobile device, computer, or other source. The second user may be identified by comparing the first user's travel information with the second user's travel information.

At block 1406, the mobile application provides an interface for the first user to communicate with the second user. The interface may be provided in response to identifying the second user. Additionally, or alternatively, the interface is provided in response to satisfying one or more criteria, such as a user's location or flight status. The interface may include a chat interface and other communication interfaces. Additionally, the mobile application may provide an interface for the first user and second user to negotiate a transaction for a seat on the travel vehicle.

In an optional configuration, communications between the first user and the second user are enabled at a pre-determined time before a scheduled departure time or when the first user checks-in for a trip identified in the first user's travel information. The communications may be disabled upon initiation of a boarding process for the travel vehicle. The communications may be enabled, or re-enabled, for a duration after the travel vehicle embarks to a destination.

In an optional configuration, or more features of the mobile application may be enabled for each user when the user has arrived at the airport. For example, a chat feature may be enabled when the first user arrives at the airport. The chat feature for the second user may be disabled until the second user arrives at the airport. The user's location may be determined based on positioning information (e.g., GPS), a user's action (e.g., physically checking-in to a flight or dropping off baggage), and/or other location verification methods.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method, comprising:
receiving a first user's travel information;
identifying at least one second user scheduled for a same travel vehicle as the first user, the at least one second user identified based on the first user's travel information and the at least one second user's travel information; and
providing an interface for the first user to communicate with the at least one second user.

2. The method of claim 1, further comprising providing an interface for the first user and the at least one second user to negotiate a transaction for a seat on the travel vehicle.

3. The method of claim 1, further comprising receiving the first user's travel information from an airline database or an input from the first user.

4. The method of claim 1, further comprising enabling communications between the first user and the at least one second user at a pre-determined time before a scheduled departure time or when the first user checks-in for a trip identified in the first user's travel information.

5. The method of claim 1, further disabling communications between the first user and the at least one second user upon initiation of a boarding process for the travel vehicle.

6. The method of claim 5, further comprising enabling communications between the first user and the at least one second user for a duration after the travel vehicle embarks to a destination.

7. The method of claim 1, further comprising granting access to a feature of an application when the first user's location is at an airport.

8. An apparatus, the apparatus comprising:
a memory; and
at least one processor coupled to the memory, the at least one processor configured:
to receive a first user's travel information;
to identify at least one second user scheduled for a same travel vehicle as the first user, the at least one second user identified based on the first user's travel information and the at least one second user's travel information; and
to provide an interface for the first user to communicate with the at least one second user.

9. The apparatus of claim 8, in which the at least one processor is further configured to provide an interface for the first user and the at least one second user to negotiate a transaction for a seat on the travel vehicle.

10. The apparatus of claim 8, in which the at least one processor is further configured to receive the first user's travel information from an airline database or an input from the first user.

11. The apparatus of claim 8, in which the at least one processor is further configured to enable communications between the first user and the at least one second user at a pre-determined time before a scheduled departure time or when the first user checks-in for a trip identified in the first user's travel information.

12. The apparatus of claim 8, in which the at least one processor is further configured to disable communications between the first user and the at least one second user upon initiation of a boarding process for the travel vehicle.

13. The apparatus of claim 12, in which the at least one processor is further configured to enable communications between the first user and the at least one second user for a duration after the travel vehicle embarks to a destination.

14. The apparatus of claim 8, in which the at least one processor is further configured to grant access to a feature of an application when the first user's location is at an airport.

15. A non-transitory computer-readable medium having program code recorded thereon, the program code executed by a processor and comprising:
program code to receive a first user's travel information;
program code to identify at least one second user scheduled for a same travel vehicle as the first user, the at least one second user identified based on the first user's travel information and the at least one second user's travel information; and
program code to provide an interface for the first user to communicate with the at least one second user.

16. The non-transitory computer-readable medium of claim 15, in the program code further comprises program code to provide an interface for the first user and the at least one second user to negotiate a transaction for a seat on the travel vehicle.

17. The non-transitory computer-readable medium of claim 15, in the program code further comprises program code to receive the first user's travel information from an airline database or an input from the first user.

18. The non-transitory computer-readable medium of claim 15, in the program code further comprises program code to enable communications between the first user and the at least one second user at a pre-determined time before a scheduled departure time or when the first user checks-in for a trip identified in the first user's travel information.

19. The non-transitory computer-readable medium of claim 15, in the program code further comprises program code to disable communications between the first user and the at least one second user upon initiation of a boarding process for the travel vehicle.

20. The non-transitory computer-readable medium of claim 19, in the program code further comprises program code to enable communications between the first user and the at least one second user for a duration after the travel vehicle embarks to a destination.

21. The non-transitory computer-readable medium of claim 15, in the program code further comprises program code to grant access to a feature of an application when the first user's location is at an airport.
